(19) United States
(12) Patent Application Publication
(10) Pub. No.: US 2014/0094041 A1
(43) Pub. Date: Apr. 3, 2014

(54) CONTACT SYSTEM

(71) Applicant: EATON CORPORATION, CLEVELAND, OH (US)

(72) Inventors: Qingqi Chen, Xiamen City (CN); Francois J. Marchand, Coraopolis, PA (US); Lihua Bao, Suzhou City (CN)

(73) Assignee: EATON CORPORATION, CLEVELAND, OH (US)

(21) Appl. No.: 14/039,522

(22) Filed: Sep. 27, 2013

(30) Foreign Application Priority Data
Sep. 28, 2012 (CN) 201210370818.3

(51) Int. Cl. H01R 13/02

(52) U.S. Cl. CPC H01R 13/02
USPC 439/11

(57) ABSTRACT

The invention is provided with a contact system (25) which comprises a first conductor (5) with a radial contact surface (6, 6′), a second conductor (8) with an axial contact surface (7) and a contact member (24) mounted on the first conductor (5) in radially displaceable mode relative to the first conductor (5). The contact member (24) comprises a first contact portion (15) and a second contact portion (16) electrically connected to each other. The first contact portion (15) of the contact member (24) contacts with the radial contact surface (6, 6′) of the first conductor (5) and is radially movable relative to the first conductor (5), and the second contact portion (16) of the contact member (24) contacts with the axial contact surface (7) of the second conductor (8) and is axially movable relative to the second conductor (8).

### TECHNICAL FIELD

The present invention relates to the technical field of electrical switchgear, specifically to a contact system for a switchgear, and more in particular to a contact system for various switchgears applicable to each of voltage levels including low voltage, medium voltage, high voltage and ultra-high voltage, e.g., for the switchgears in form of breaker, isolating switch, switch cabinet or the like.

### BACKGROUND

It is well known in the art that in various electrical apparatus, a switch is widely used for switching on or off current of the electrical apparatus, and the switch-on/off of the current is usually carried out by a contact system of the switch. In general, the contact system comprises a movable contactor mounted on a movable conductor, and a fixed contactor included in a fixed conductor or constituting a part of the fixed conductor. The movable conductor and thus the movable contactor are movable with respect to the fixed conductor (fixed contactor) so as to switch on or off an electric connection with the fixed conductor. Generally speaking, one of the movable conductor and the fixed conductor is in shape of a rod, while the other defines an opening for the rod-shaped conductor to be inserted into or pass through, such that the direction of relative movement of the movable conductor and fixed conductor is substantially along the axial direction of the rod-shaped conductor.

As known by a person skilled in the art, contacting performance of contact fingers, between the movable and fixed contactors, or between the movable contactor and fixed conductor, in the contact system is very important to reliability, stability and service life of the electrical apparatus. Bad connecting performance (connecting pressure and stability) of the contact finger may result in accidents like overheat of the contactor, excessive instantaneous current, virtual connection, and even explosion.

In the known contact systems, with the aim to keep the contacting performance of the contact finger, it is common to ensure an absolute coaxiality of the movable conductor (contact member) and the fixed conductor through various means, such as by controlling the movement accuracy of the movable conductor and/or securing the contact base of the movable contactor fixedly on the movable conductor. For instance, Chinese utility model patent ZL201020670038.7 is provided with a tulip contactor, wherein a groove is formed on outer periphery of a contact finger, and a spiral spring mounted in the groove around the contactor, such that when short-circuit current occurs in the tulip contactor, contraction electrodynamic force is generated because of the current flowing through a contacting point, and thus the electrodynamic stability of the contactor is assured in view of the electrodynamic force and a clamping force of the spring, such that the tulip contactor is securely positioned around the movable conductor, so as to avoid a displacement.

In order to further ensure the contacting performance of the contact finger, multiple known contact systems, such as the prior art self-elastic contactor and non-self-elastic contactor, are developed to equip contact portions of the contractor with elastic property through various means, such that the contact portion of the movable contactor still keeps contacting with the contact portion of the fixed conductor or fixed contactor even in the event that the movable and fixed conductors (movable and fixed contactors) are slightly uncoaxial, as is detailedly described in the Background of Chinese invention patent ZL200810042143.3, of which the contents are incorporated herein by reference. Each of the contactors, regardless of self-elastic contactor or non-self-elastic contactor, is designed to equip the contact portions of the contactor with elastic property, with the contact base for supporting or coupling the contact portions being fixedly connected to the movable conductor, in order to ensure the coaxiality of the movable conductor and contact member with respect to the fixed conductor. In the patent ZL200810042143.3 is also provided a tulip contact system, in which a main contactor comprises a contact base having a containing portion and a connecting portion, and a plurality of contact fingers circumferentially arranged in the containing portion; wherein each contact finger is provided with a contact portion and a support portion fastened to the containing portion by a screw, the contact portions of each contact finger together form a contact ring, a spring is arranged between the support portion of each contact finger and the contact portion of one adjacent contact finger; and the contact ring and the connecting portion contact with or are connected to a contacting arm. The plurality of the contact fingers of the tulip contact system have a new structure to prevent the spring from being exposed or damaged, but the contact base of the tulip contact still has to be securely fixed to the movable conductor. Because of limited elasticity of the contact fingers and spring, the contact system is not sufficient to compensate uncoaxiality of the main contact and contacting arm. Moreover, although the contact system might have been capable of compensating a slight uncoaxiality between the contactor and the contacting arm to keep contacting therebetween, such uncoaxiality would still lead to non-uniform contacting performance (contacting pressure) between the contact portion of each contact finger and the contacting arm, and further result in non-uniform current conduction, thereby degrading the conductivity.

Therefore, there still is a need for a contact system which is capable of providing good contacting performance of the contact without high restriction on coaxiality of movable and fixed conductors (contactors).

### SUMMARY OF INVENTION

In an aspect of the present invention, a contact system comprises a first conductor with a radial contact surface; a second conductor with an axial contact surface; and a contact member mounted on the first conductor in radially displaceable mode relative to the first conductor. The contact member has a first contact portion and a second contact portion, wherein the first contact portion and the second contact portion are electrically connected to each other. The first contact portion of the contact member contacts with the radial contact surface of the first conductor and is radially movable relative to the first conductor, and the second contact portion of the contact member contacts with the axial contact surface of the second conductor and is axially movable relative to the second conductor.

The conductor of the present invention may have various shapes, including a shape of rod. The axial direction as used in the present invention can nevertheless be defined substantially in a manner as mentioned before in Background. That is, the general direction, along which the relative movement between the conductors is performed, can be considered as the axial direction, and thereby the general direction perpendicular to the axial plane can be considered as the radial direction, and the general direction around the axial direction can be considered as the periphery direction.

Preferably, the contact member may comprise a holder (contact base) and a contact finger mechanism mounted on the holder in a floatable or elastic manner.

In the contact system according to the present invention, a contact member, in particular a novel configuration of the contact base (holder) and the first conductor (e.g. a conductive rod), is provided. In contrast, the prior art contact base is required to be connected fixedly with the first conductor, such that the first conductor and thus the contact member can have a certain coaxiality with respect to the second conductor. It is noted surprisingly by the inventor that in the contact system according to the present invention, when the first conductor, the contact member (contact portion) and the second conductor are to be engaged or disengaged with each other or remain engagement, the contact finger mechanism, especially the second contact portion, of the contact member contacts with the second conductor under a substantively uniform pressure, even if the first conductor is not coaxial with the second conductor or has a radial displacement with respect to the contact base and the second conductor. The uniform contact and pressure may be resulted from that after the second contact portion of the contact member connects with the axial contact surface of the second conductor, the radial position of the contact member will be mainly defined or restricted by the second conductor, whereas a radial offset or displacement of the first conductor within a certain range will not significantly affect the radial position of the contact member and especially of the holder. Thereby, when the first conductor is radially offset or displaced with respect to the second conductor, the first contact portion of the contact member still keeps in contact with the radial contact surface of the first conductor, and more importantly, the second contact portion of the contact member keeps in contact with the axial contact surface of the second conductor, with little effect on the contact performance such as the contact pressure by the radial displacement or offset of the first conductor.

In this regard, it could be conceivable that configuration of relatively radial displacement between the contact member and the first conductor can be accomplished by multiple means. For example, the contact member is undetachably mounted to the first conductor in a radial lost-motion fit or sliding-friction fit mode, such that the radial movement of the first conductor with respect to the contact base needs merely to overcome a certain friction force, such as a friction force between the first contact portion and the radial contact surface of the first conductor and/or a friction force between a sliding member, if any and the first conductor or contact member, without significantly changing the radial position of the contact member and in particular of the contact base.

Thus, it could be conceivable that except the friction force if any, preferably no mechanism for transferring a radial force, such as no spring mechanism for transferring radial spring force, is to be arranged between the contact member, especially the contact base, and the first conductor. It could be also understood that in the present invention, an axial elasticity may be provided between the contact member and the first conductor so as to move axially with respect to each other, for example by means of the elasticity of the first contact portion or of the sliding member, if any. Nevertheless, it is advantageous to avoid significantly axially relative movement between the contact base and the first conductor, in order to keep a uniform contact pressure between the first contact portion and the first conductor. In other words, the axial position of the contact member comprising the contact finger mechanism and the contact base is mainly defined or restricted by the first conductor.

According to an especially preferable embodiment of the present invention, the radially displaceable arrangement between the contact base and first conductor is achieved for example by a lost-motion fit or sliding-friction fit between the containing groove and a respective contained portion (e.g. a projection).

In an embodiment, the first conductor comprises a containing groove in which the contact base is contained with a radial gap from the containing groove (bottom of the groove), the radial contact surface being accordingly defined in the containing groove.

In an alternative embodiment, the contact base is provided with a containing groove, and the first conductor is provided with a projection contained in the containing groove with a radial gap between the projection and the bottom of the containing groove, wherein the radial contact surface is defined in the projection.

Accordingly, the contact member, especially the contact base, may comprise an aperture in which the first or second conductor can be inserted, i.e. the contact member is substantially in shape of a closed ring, such as in shape of circular, rectangular or other polygonal rings. It is conceivable that the contact member is preferably an integral ring, but also can be a ring consisting of a plurality of contact member segments, as long as upon engagement, the axial and radial positions of the ring are maintained by the first and second conductors respectively. Similarly, the containing groove may be configured in form of a ring groove.

Preferably, the radial position of the contact member can be retained by the friction force between the contact member and the first conductor, such as the friction force between the first contact portion and the first conductor, the friction force between the contact base and first conductor, or the friction force between the respective sliding member and the contact member or the first conductor, without application of any external mechanism, e.g. only under the gravity. For example, during the movement of the first conductor and the contact member where neither of them have contacted with the second conductor yet, the contact member is retained in a radial position with respect to the first conductor, without contacting the contact base with the bottom of the containing groove in form of circular groove along its entire circumference. That is to say, the contact base will not rest on a portion of the bottom of the containing groove under gravity.

In an embodiment of the present invention, the first conductor is in shape of a rod substantially extending axially, for example, is configured as a conductive rod. Accordingly, the second conductor comprises a recess-shaped or through hole-shaped opening for containing the contact member and/or the first conductor.

In another embodiment of the present invention, the second conductor is in shape of a rod substantially extending axially, for example, is configured as a conductive rod. Accordingly, the first conductor comprises a recess-shaped or through hole-shaped opening for containing the second conductor.

According to the configuration of the first conductor and second conductor, the containing groove of the first conductor, if any, is accordingly provided on outer periphery of the first conductor or on inner periphery of the opening of the first conductor. As an alternative, the containing groove of the contact member, if any, is accordingly provided on outer periphery thereof or on inner periphery of the aperture of the contact member.

Preferably, the contact member is configured as a movable contactor, and the second conductor is provided with a fixed contactor and/or the second conductor is fixed, and vice versa.

According to a preferable embodiment, the first conductor comprises a conductive body, and a retainer fastened to the body, e.g. through a screw, and the containing groove of the first conductor is defined by the body and the retainer. The retainer may be conductive or non-conductive. Where the retainer is conductive, the first contact portion of the contact member is contactable with the radial contact surface defined in the retainer.

As an alternative embodiment, the first conductor is provided with no retainer, and the containing groove is integrally formed in the first conductor.

According to a specific embodiment of the present invention, the contact member may comprise a contact base or holder, at least one contact finger defining the first and second contact portions, and a spring disposed between the holder and each contact finger, wherein the spring is mounted on the holder in an angle from to the radial direction. Preferably, the contact member further comprises a stopping mechanism securely connected to or integrally formed with the holder, wherein the stopping mechanism is configured to limit or restrain the contact finger from moving in a direction away from the spring.

More specifically, the contact finger is configured as a cup-shaped contact finger, and the contact base further comprises a contact finger slot for containing the cup-shaped contact finger and the spring.

The contact base is preferably non-conductive, which is beneficial to a decrease or elimination of current bypass from the contact base.

Preferably, the contact member may comprise a row of the contact fingers, or multiple rows of the contact fingers arranged side by side around the periphery of the holder.

According to another embodiment of the present invention, the contact member may comprise an electrically conductive holder, a first contact blade or finger defining the first contact portion, and a second contact blade or finger defining the second contact portion.

According to a further preferred embodiment, the contact member may comprise around a periphery of the holder one first circular contact finger and one second circular contact finger arranged side by side.

As an alternative, the contact member may comprise around the periphery of the holder two first circular contact fingers arranged side-by-side and one second circular contact finger arranged between the two first contact fingers.

As an alternative or in addition to the contact finger mechanism of the contact member, the conductor according to the present invention can accordingly be provided with a contact finger. Specifically, the radial contact surface of the first conductor is provided with a contact finger electrically connected to the first contact portion. As a feasible but less preferable embodiment, the axial contact surface of the second conductor is provided with a contact finger electrically connected to the second contact portion.

Preferably, the contact blade or finger of the present invention is per se of elastic, for example, is configured as a self-elastic contact blade, as an alternative or in addition to the aforesaid spring.

For decreasing friction of the movement or sliding between the contact base and the first conductor, the contact system further comprises a sliding member disposed between the first conductor and the contact base, and a respective groove.

There are other features and advantages of the present invention, part of which are obvious to the person skilled in the art after reading the specification, and the others will be described hereinafter in the specific embodiments with reference to the accompanying drawings.

### BRIEF DESCRIPTION OF FIGURES

The present invention is detailed by referring to the specific embodiments with reference to the accompanying drawings, in which:

FIGS. 1A-1C illustrate one embodiment of the contact member in the contact system according to the present invention;

FIG. 2 illustrates a first embodiment of the contact system according to the present invention, in which the contact member of FIG. 1 is shown;

FIG. 3 illustrates another embodiment of the contact member in the contact system according to the present invention;

FIG. 4 illustrates a second embodiment of the contact system according to the present invention, in which the contact member of FIG. 3 is shown;

FIG. 5A and FIG. 5B illustrate further another embodiment of the contact member in the contact system according to the present invention;

FIG. 6A and FIG. 6B illustrate yet another embodiment of the contact member in the contact system according to the present invention;

FIG. 7 illustrates a third embodiment of the contact system according to the present invention;

FIG. 8 illustrates a fourth embodiment of the contact system according to the present invention;

FIG. 9 illustrates a fifth embodiment of the contact system according to the present invention.

The same or similar reference numerals in the present invention are intended to represent the same or similar features or elements.

### DETAILED DESCRIPTION OF EMBODIMENTS

Exemplary embodiments of the claimed device will be described with reference to the following detailed description and figures. Although the figures are provided to represent some embodiments of the present invention, the drawings are not required to be drawn in scale, and some features can be enlarged, removed or cross-sectioned to better illustrate the present invention.

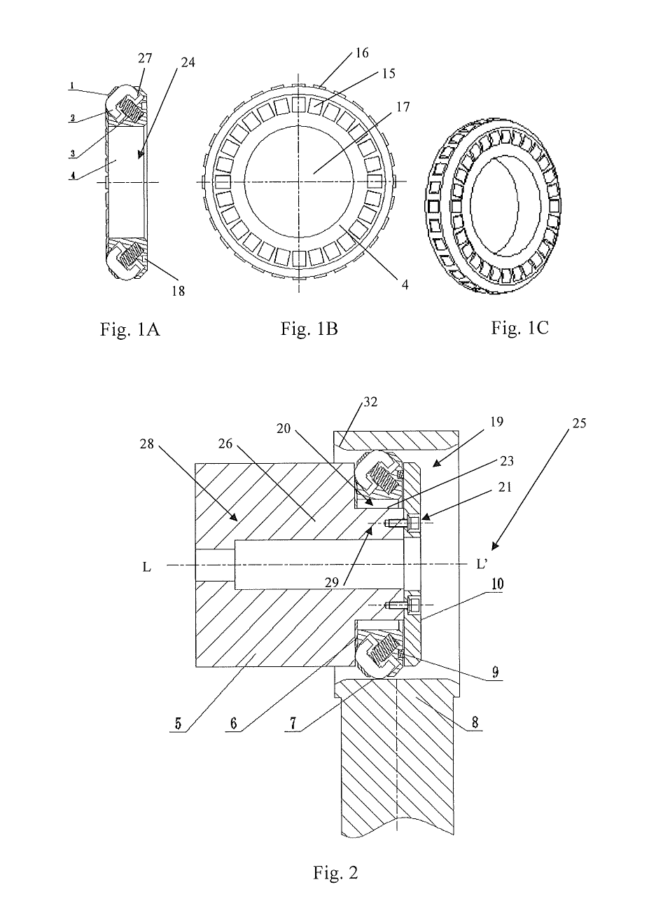

As illustrated in FIGS. 1A-1C, a contact member 24 of the present invention comprises a holder or contact base 4, a row of cup-shaped conductive contact fingers 2 arranged around an outer periphery of the holder 4, and a spring 3 arranged between the holder 4 and each of the cup-shaped contact fingers 2. A plurality of contact finger slots 27 are formed in the holder 4, and one of the cup-shaped contact fingers 2 and the springs 3 are contained in each of the contact finger slot 27. The spring 3 is mounted in the contact slot 27 in an angle from radial direction, such that the contact fingers are provided with longitudinal and radial elastic/floating ability.

As shown in FIGS. 1A-1C, the contact member 24 further comprises a press plate 1 integrally formed with the holder 4. Optionally, the pressure plate 1 is configured to pre-press the spring 3. FIGS. 1B and 1C illustrates the integrally formed circular press plate 1. The press plate 1 is connected with the holder at multiple positions through an integrated connecting rod (not shown). The contact finger 2 and the spring 3 are positioned in the contact finger slot under the press plate 1, so as to limit or restrain the contact FIG. 2 from moving in a direction away from the spring 3. As an alternative to the illustrated press plate 1, it is conceivable to provide any appropriate stopping mechanism, such as a plurality of press plates fixedly connected to or integrally formed with the holder 4, each for the respective contact finger.

Further referring to FIGS. 1B and 1C, the contact finger 2 comprises a first contact portion 15 on a side of the contact member 24, and a second contact portion 16 disposed on the outer periphery of the contact member 24. Furthermore, the contact member 24 (holder 4) is substantially in shape of a circular ring and comprises an aperture 17. As shown in FIG. 1A, a groove 18 for containing a sliding member is formed in the holder 4 on one side where no contact FIG. 2 is arranged.

Further referring to FIG. 2, a contact system 25 is shown comprising the contact member 24 of FIG. 1. As shown in FIG. 2, the contact system 25 comprises a first conductor 5, a second conductor 8, and the contact member 24 mounted on the first conductor 5. As illustrated, the first conductor 5 is in shape of a rod extending substantially along an axis LL′, and the second conductor 8 is provided with an opening 19 for containing the first conductor and the contact member. As illustrated, the opening 19 is generally arranged coaxially with the rod-shaped first conductor. However, as described by the disclosure, the first conductor 5 is allowed to be radially offset with respect to the opening 19.

Collectively referring to FIGS. 1A-1C and FIG. 2, the first conductor 5 comprises a conductive body 26, and a retainer 10 fastened to the body 26 through a screw 21. In this embodiment, the retainer 10 is preferably non-conductive. As illustrated, the conductive body 26 comprises a major diameter portion 28 and at a tip end, a minor diameter portion 29. The minor diameter portion 29 has a diameter smaller than that of the aperture 17, such that the body 26 and the retainer 10 together define a radially outward containing groove 23. As illustrated in FIG. 2, when installation, the holder 4 of the contact member 24 is positioned over the minor diameter portion 29 of the body 26 through the aperture 17, and subsequently the retainer 10 is fastened to the body 26 through the screw 21 and accordingly the containing groove 23 is formed, with a radial gap 20 between the holder 4 and the bottom of the containing groove 23, such that the contact member 24, in particular the holder 4, is radially displaceable with respect to the first conductor 5. It could be conceivable by the person skilled in the art that the above-mentioned gap or the diameter difference between the major diameter portion 28 and the minor diameter portion 29 allows the radial displacement of the holder of the present invention with respect to the first conductor. The retainer and the body are separated In the illustrated embodiment, but they can be formed integrally, as long as the contact member 24 is contained in the containing groove with the radial gap.

As shown in FIG. 2, a side wall of the containing groove 23 in the first conductor 5 defines a radial contact surface or radial displacement working surface 6 which contacts and is electrically connected with the first contact portion 15, and the opening 19 of the second conductor 8 defines an axial contact surface or axial displacement working surface 7 which contacts with the second contact portion 16. As a result, the contact member 24 is allowed to be radially displaceable along the radial contact surface 6 with respect to the first conductor 5, with the electrical connection with the first conductor 5. Likewise, the contact member 24 is allowed to be axially displaceable along the axial contact surface 7, with the electrical connection with the second conductor 8.

Collectively referring to FIGS. 1A-1C and FIG. 2, the contact system further comprises a sliding ring 9 disposed between the holder and the holder 4. The sliding ring 9 is contained in the groove 18 of the holder. The sliding ring 9 is particularly applicable to decrease friction between the contact member 4 and the first conductor 5.

In the contact system as shown in FIG. 2, the contact member 24 is configured as a movable contactor, and the second conductor 8 is fixed or provided with a fixed contactor (not shown) as known in the prior art such that the first conductor 5 and the contact member 24 is movable along the axial direction, such as along the axis LL′, into the opening of the second conductor 8, such that the second contact portion 16 of the contact finger 2 is movable along the axial contact surface 7.

Upon engaging the first conductor 5 with or disengaging the first conductor 5 from the second conductor 8 or during the engagement therebetween, if an uncoaxial situation or radial offset between the first conductor 5 and the second conductor 8 occurs, because of the above-mentioned gap (the diameter difference), there is little resistance to the radial movement of the first conductor 5 within a certain range (e.g. by only overcoming the friction between the first contact portion 15 of the contact finger 2 and the body 26, and between the sliding ring 9 and the retainer), and the radial position of the contact member 24 will be still retained or defined by the second conductor 8 (the opening 19). That is, the radial movement of the first conductor 5 causes the minor diameter portion 29 of the body to move in the aperture 17, without contacting with the holder. On the other hand, upon engaging the first conductor 5 with or disengaging the first conductor 5 from the second conductor 8 or during the engagement therebetween, the axial position of the contact member 24 is retained by the first conductor 5. As illustrated, a noticeable axial movement of the contact member 24 with respect to the first conductor 5 is restricted by the containing groove 23 defined by the body 26 and the retainer 10. At the same time, the first conductor 5 and the contact member 24 are axially movable together with respect to the second conductor 8.

Back to FIGS. 1A-1C, the integral contact member 24 is shown. Nevertheless, because of the nature of the present invention, in a less preferable embodiment, the contact member of the present invention, for example, comprises multiple contact member parts (not shown) that collectively form a closed ring, the radial and axial positions of the ring being respectively retained by the first and second conductors, such that the contact member is still allowed to be radially or axially movable with respect to the first or second conductor, respectively.

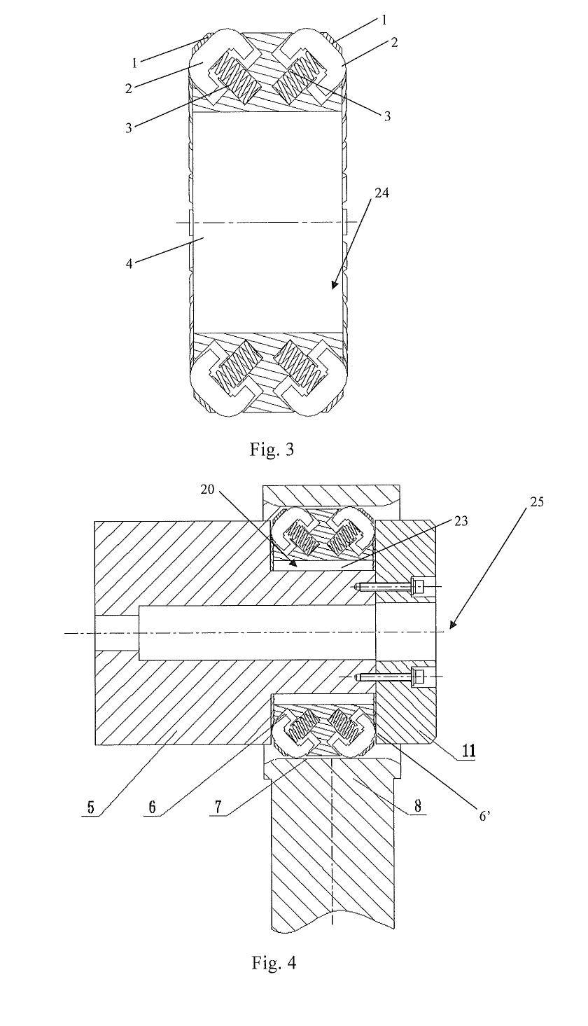

Referring to FIG. 3, another embodiment of the contact member 24 is illustrated. The components of the contact member 24 are similar to those shown in FIG. 1, except that the contact finger mechanism of FIG. 3 comprises two rows of the cup-shaped contact fingers 2 arranged side by side, two respective rows of the springs 3, and two press plates 1. In view of the configuration of the two rows of the contact fingers, the contact member 24 is dispensed from the sliding ring 9 and the groove 18, as shown in FIG. 3. However, it is also conceivable that the sliding member and the groove are arranged at other positions between the first conductor 5 and the contact member 24.

Referring to FIG. 4, a contact system 25 is shown comprising the contact member 24 of FIG. 3, which contact system 25 is configured similarly to the contact system of FIG. 2, for example, the containing groove 23 for containing the contact member 24 is defined between the body 26 and the retainer 10 of the first conductor 5, and the radial gap 20 is formed between the bottom of the containing groove 23 and the holder 4, with a difference that the first contact portion 15 of one row of the contact fingers 2 of the contact member 24 in FIG. 4 is in contact and electric connection with the body 26 of the first conductor 5, while the first contact portion 15 of the other row of the contact fingers 2 is in contact and electric connection with a conductive retainer 11 of the first conductor 5. That is, the body 26 and the retainer 11 of the first conductor 5 each define a radial contact surface 6, 6′ respectively. The second contact portion 16 of each contact finger 2 is still in contact and electric connection with the axial contact surface 7 of the second conductor 8.

Referring to FIGS. 5A and 5B, further another embodiment of the contact member 24 is illustrated. At least part of elasticity and floatability of the contact finger mechanism in the embodiments of FIGS. 1-4 and 7 is provided by the springs, while the elasticity of the contact finger mechanism in FIGS. 5A and 5B are completely provided by the contact blade or contact finger per se. Moreover, as compared to what is illustrated in FIGS. 1-4 and 6 that the contact finger 2 of the contact finger mechanism defines both the first contact portion 15 and the second contact portion 16, the contact finger mechanism of the contact member 24 as shown in FIGS. 5A and 5B comprises a first circular contact finger 13 defining the first contact portion 15, and a second circular contact finger 12 defining the second contact portion 16. The first contact finger 13 is arranged on a side of the contact member 24 and in contact with the radial contact surface 6 of the first conductor 5, and the second contact finger is arranged on an outer periphery of the contact member 24 and in contact with the axial contact surface 7 of the second conductor 8. As a result, the contact member 24 comprises a holder 14 which at least electrically connects the first contact finger 13 with the second contact finger 12. For example, the holder 14 is made from electrically conductive materials. As illustrated in FIGS. 5A and 5B, the first and second contact fingers 12 and 13 are mounted and retained on the holder 4, such that the stopping mechanism can be omitted from the contact member 24 of the embodiment. The illustrated first contact finger and second contact finger is in form of a ring-shaped integral contact finger respectively, but it is conceivable to provide a plurality of first and second contact fingers similar to the above-mentioned embodiments.

Similar to the embodiment of FIGS. 1A-1C, the contact member 24 may comprise a groove for containing the sliding ring 9.

The contact member of the contact system as shown in FIG. 2 can be replaced with the contact member 24 of the embodiment as shown in FIGS. 5A and 5B to form a new contact system. In addition, features of the contact fingers (contact blades) of the said embodiment and of the above-mentioned embodiments can be interchanged or combined with each other to yield a new embodiment of the contact member. For example, the contact fingers in FIGS. 1A-1C can be modified to have elasticity per se to provide elasticity for the contact finger mechanism, or the first and second contact fingers in FIG. 5 can be equipped with a spring.

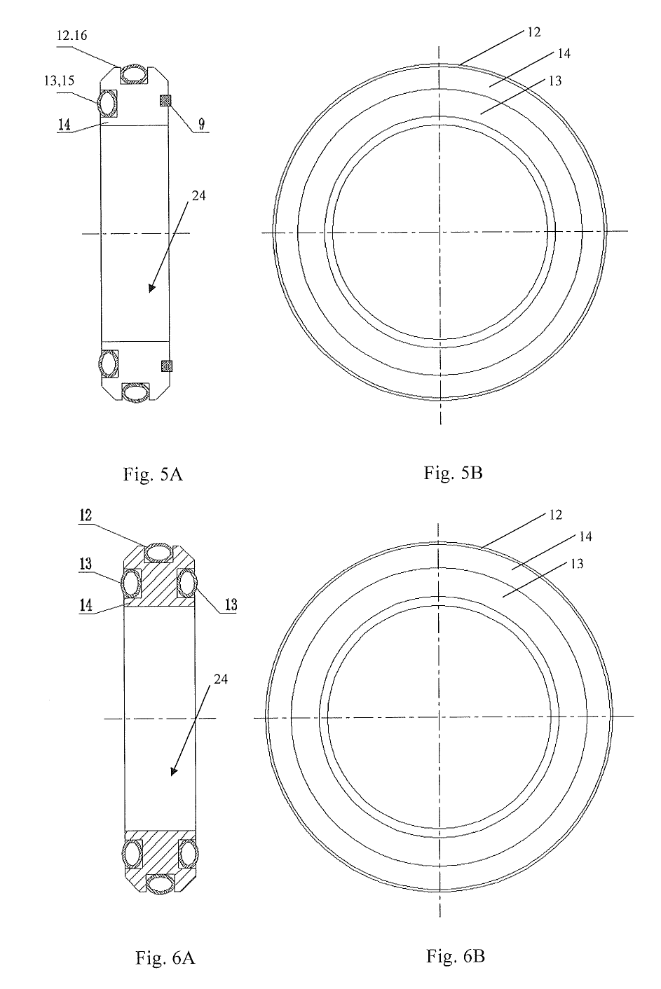

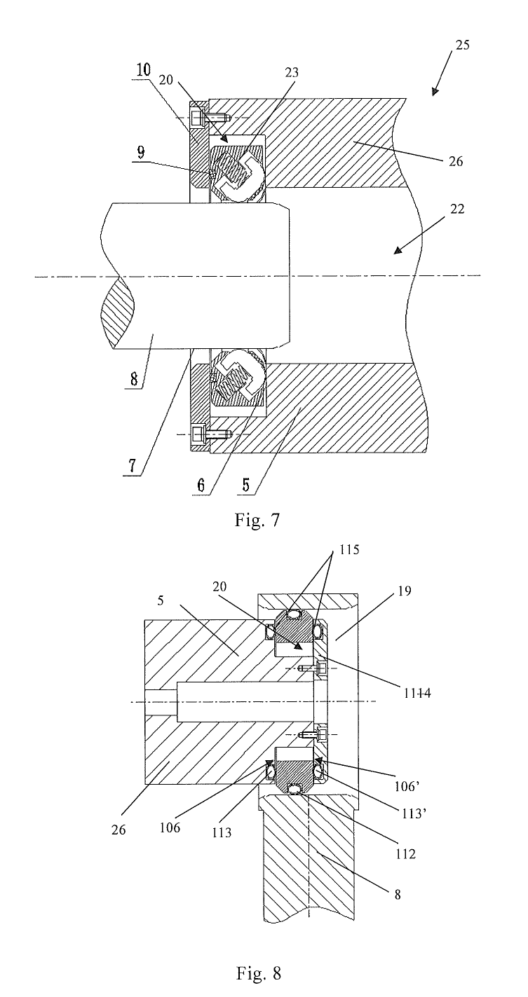

Referring to FIGS. 6A and 6B, yet another embodiment of the contact member is illustrated. The embodiment illustrated in FIGS. 6A and 6B is similar to the embodiment of FIGS. 5A and 5B, except that in replacement of the groove in the contact member of FIGS. 5A and 5B, another juxtaposed circular first contact finger (contact blade) 13 is arranged in the contact member 24 of FIGS. 6A and 6B. In other words, the contact finger mechanism of the contact member 24 comprises around the periphery of the holder, two first contact fingers arranged side by side and one second contact finger arranged between the two first contact fingers, with the two first contact fingers, for example, contacting with the radial contact surface 6, 6′ of the body and of the retainers 10 and 11 in the first conductor 5 respectively, while the second contact finger contacting with the axial contact surface 7 of the second conductor 8.

The contact member of the contact system as shown in FIG. 4 can be replaced with the contact member 24 of the embodiment as shown in FIGS. 6A and 6B to yield a new contact system.

Further referring to FIG. 7, still another embodiment of the contact system 25 according to the present invention is illustrated. The main difference between this contact system and the above-mentioned contact system lies in that the second conductor 8 of the contact system in FIG. 7 is in shape of a rod substantially extending along the axial direction, and the first conductor 5 is provided with a respective opening or aperture 22. Similar to the above-mentioned embodiments, the first conductor 5 is provided with a body 26, a retainer 10, and a containing groove 23 defined by the body 26 and the retainer 10 for containing the contact member, with a radial gap 20 between the bottom of the containing groove 23 and the holder of the contact member, but the containing groove 23 is directed radially inward. With regard to the other components of the contact system of FIG. 7, reference can be made to the above-mentioned embodiments of contact member, with their combination and modification falling within the scope of the present invention.

It is shown in all the above-mentioned embodiments that the contact fingers are mounted on the contact member. As an alternative or in addition, however, the contact finger can be accordingly arranged on the first conductor and/or the second conductor. As shown in FIG. 8, the radial contact surface 106 of the body 26 and the radial contact surface 106′ of the retainer 14 in the first conductor 5 are both provided with the first contact blades or fingers 113, 113′ respectively. Accordingly, no contact finger is arranged in the first contact portion 115 of the contact member. As illustrated, the contact member is still provided with the second contact blade or contact finger 112 for defining the second contact portion of the contact member (not indicated). It is conceivable that although less preferable, as an alternative, the axial contact surface of the second conductor 8 is provided with the contact finger for contacting with the second contact portion of the contact member. With regard to the other components of the contact system of FIG. 8, reference can be made to the above-mentioned embodiments of contact member.

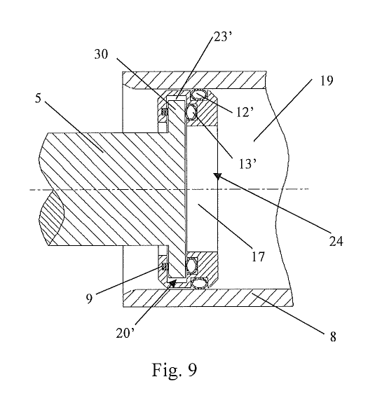

As an alternative to the containing groove 23 arranged in the first conductor 5, it is conceivable that a respective containing groove 23′ is arranged in the contact member. As shown in FIG. 9, the rod-shaped first conductor 5 and the second conductor for defining the opening 19 are provided. The containing groove 23′ directed radially inward is formed in an aperture 17 of the contact member 24. Accordingly, the first conductor 5 is provided with a projection 30 thereon, which is contained in the containing groove 23′ with a radial gap 20′. In this embodiment, the first contact portion and the second contact portion of the contact member 24 are respectively defined by a first contact finger 13′ and a second contact finger 12′ arranged thereon. The first contact finger 13′ is arranged on a side wall of the containing groove 23′, i.e., within the inner periphery of the opening 17 of the contact member 24, and in contact with the radial contact surface (not indicated) defined in the projection 30 of the first conductor 5. The second contact finger 12′ is arranged on the outer periphery of the contact member and in contact with the axial contact surface (not indicated) of the opening 19 of the second conductor 8. With such arrangement, the above-mentioned radial displacement of the contact member 24 with respect to the first conductor 5 can be also achieved by the containing groove 23′ and the projection 30. With regard to the other components of the contact system of FIG. 8, reference can be made to the above-mentioned embodiments of contact member. A combination between the aforesaid contact system and the containing groove of contact base may yield a new embodiment. For example, the containing groove formed on the outer periphery of the contact base 24 is applicable to a configuration in which the second conductor is in a shape of rod and the first conductor defines the opening. Furthermore, the positions and arrangements of the contact fingers are applicable to be combined with the current embodiment to yield a new embodiment.

It could be understood that, although the preceding preferable embodiments each defines that the first conductor is movable and thus the contact member of the present invention is configured as a movable contactor, the second conductor can be movable or a contactor is provided on the second conductor as a movable contactor, with the first conductor and the contact member of the present invention to be axially stationary, which also falls within the scope of the present invention.

Although in the disclosure there are various embodiments to illustrate the details of the present invention, the applicant does intend to limit or otherwise restrict the scope of the present invention to the details. Various advantages and modification would be apparent to the person skilled in the art, after reading the disclosure. Therefore, modification, such as interchange, combination, modification of the features of the embodiments, can be made without departing from the scope and spirit of the present invention. In particular, it is undoubted that the person skilled in the art can combine and interchange the features in different embodiments as illustrated in the figures to yield a new embodiment. The scope of the invention is not limited to the above description, but by the appendix claims and any equivalencies thereof.

1. A contact system, comprising:
a first conductor with a radial contact surface;
a second conductor with an axial contact surface; and
a contact member mounted on the first conductor in radially displaceable mode relative to the first conductor, the contact member having a first contact portion and a second contact portion electrically connected to each other,
wherein the first contact portion of the contact member contacts with the radial contact surface of the first conductor and is radially movable relative to the first conductor, and the second contact portion of the contact member contacts with the axial contact surface of the second conductor and is axially movable relative to the second conductor.

2. The contact system of claim 1, wherein the axial contact surface of the second conductor defines a radial position of the contact member.

3. The contact system of claim 1, wherein the contact member comprises an aperture into which the first conductor or the second conductor is inserted.

4. The contact system of claim 1, wherein the first conductor comprises a containing groove, wherein the contact member is contained in the containing groove with a radial gap from the containing groove, and the radial contact surface is defined in the containing groove.

5. The contact system of claim 4, wherein the first conductor is in shape of a rod substantially extending axially, and the second conductor comprises an opening for containing the contact member and/or the first conductor, the containing groove being arranged around an outer periphery of the first conductor.

6. The contact system of claim 4, wherein the second conductor is in shape of a rod substantially extending axially, and the first conductor comprises an opening for containing the second conductor, the containing groove being arranged around an inner periphery of the opening of the first conductor.

7. The contact system of claim 4, wherein the first conductor comprises an electrically conductive body and a retainer secured on the body, the containing groove being defined by the body and retainer.

8. The contact system of claim 4, wherein the containing groove is formed integrally in the first conductor.

9. The contact system of claim 3, wherein the first conductor comprises a projection, and the contact member comprises a containing groove, the projection being contained in the containing groove with a radial gap from the containing groove, and the radial contact surface being defined in the projection.

10. The contact system of claim 9, wherein the first conductor is in shape of a rod substantially extending axially, and the second conductor comprises an opening for containing the contact member and/or the first conductor, the containing groove being arranged around a periphery of the aperture of the contact member.

11. The contact system of claim 9, wherein the second conductor is in shape of a rod substantially extending axially, and the first conductor comprises an opening for containing the second conductor, the containing groove being arranged around an outer periphery of the contact member.

12. The contact system of claim 1, wherein the contact member comprises a holder, at least one contact finger defining the first and second contact portions, and a spring disposed between the holder and each contact finger, the spring being mounted on the holder in an angle from the radial direction.

13. The contact system of claim 12, wherein the contact member further comprises a stopping mechanism securely connected to or integrally formed with the holder, the stopping mechanism being configured to limit or restrain the contact finger from moving in a direction away from the spring.

14. The contact system of claim 12, wherein the holder is not electrically conductive.

15. The contact system of claim 12, wherein the contact member comprises a row of the contact fingers or multiple rows of the contact fingers arranged side-by-side around a periphery of the holder.

16. The contact system of claim 1, wherein the contact member comprises an electrically conductive holder, a first contact finger defining the first contact portion, and a second contact finger defining the second contact portion.

17. The contact system of claim 16, wherein:
the contact member comprises around a periphery of the holder one first circular contact finger and one second circular contact finger arranged side-by-side; or
the contact member comprises around the periphery of the holder two first circular contact fingers arranged side-by-side, and one second circular contact finger arranged between the two first contact fingers.

18. The contact system of claim 1, wherein the radial contact surface of the first conductor is provided with a contact finger electrically connected to the first contact portion and/or the axial contact surface of the second conductor is provided with a contact finger electrically connected to the second contact portion.

19. The contact system of claim 1, wherein the contact system further comprises a sliding member disposed between the first conductor and the holder, and a groove for holding the sliding member.

20. The contact system of claim 1, wherein the contact member is generally in form of circular or rectangular.
